(19) United States
(12) Patent Application Publication
(10) Pub. No.: US 2026/0299675 A1
(43) Pub. Date: Oct. 1, 2026

(54) SYSTEM AND METHODS FOR MONITORING AND CAPTURING OBJECTS

(71) Applicant: IoT Technologies LLC, La Jolla, CA (US)

(72) Inventors: Abraham GREENBOIM, La Jolla, CA (US); Abdul Mannan, Islamabad (PK)

(21) Appl. No.: 19/375,841

(22) Filed: Oct. 31, 2025

Related U.S. Application Data
(63) Continuation of application No. 19/351,958, filed on Oct. 7, 2025.
(60) Provisional application No. 63/780,903, filed on Mar. 31, 2025.

(51) Int. Cl. G06F 1/3296

(52) U.S. Cl. CPC G06F 1/3296

(57) ABSTRACT

A system for monitoring and capturing one or more objects, comprising: a capturing unit, configured to target a specific category of object; one or more sensors, configured to generate signals indicative of an interaction activity; a microcontroller, configured to operate in a low-power mode and awaken upon receiving an interrupt signal from the sensor, and increment an interrupt counter and: when the interrupt corresponds to a first occurrence, in a given detection sequence, record a timestamp corresponding to the current time, and return to a low power or sleep state; a local data processor configured to pre-process the sensor signals, wherein preprocessing the sensor signals comprises: for subsequent interrupts, determine whether the elapsed time since the first interrupt exceeds a predetermined time threshold, when the elapsed time exceeds the threshold, is classify the event as a “sniffing” event, transmit a corresponding notification via a communication module, cause the system to return to the sleep state, and when the elapsed time does not exceed the threshold, determine whether the interrupt counter exceeds a predetermined count threshold, when the count threshold is exceeded, classify the event, and transmit a corresponding notification via a communication module; a communication module configured to transmit classified interaction data; and a user interface for real-time visualization of activity or notifications.

### CROSS-REFERENCE TO RELATED APPLICATIONS

The present application is a continuation of U.S. application Ser. No. 19/351,958, filed Oct. 7, 2025, which claims priority from provisional patent application No. 63/780,903, dated Mar. 31, 2025, which is incorporated herein by reference as if set forth in full.

### BACKGROUND

### Field

The present disclosure relates to a system and apparatus for monitoring and capturing objects, and more particularly, to an interrupt-driven, machine learning based system and apparatus designed for specific object types and configured to blend into various environments.

### Description of the Related Art

Pests are organisms such as insects, rodents, and other small animals that interfere with human activities by invading living spaces, damaging crops, contaminating food supplies, or transmitting diseases. Common household and commercial pests include cockroaches, ants, flies, mosquitoes, rats, and termites. These pests not only cause physical damage to infrastructure and stored goods but also pose serious health hazards. For instance, cockroaches and rodents are known carriers of allergens and bacteria, while mosquitoes are vectors for deadly diseases such as malaria, dengue, and Zika virus. Prolonged exposure to pest-infested environments can lead to respiratory problems, skin irritations, foodborne illnesses, and psychological discomfort.

Controlling pests is critical for maintaining hygiene, public health, food safety, and the structural integrity of residential, commercial, and industrial environments. Traditionally, pest control has relied heavily on chemical-based methods such as insecticides, rodenticides, and fumigation. While these methods may offer short-term effectiveness, they cause serious concerns related to environmental pollution, toxicity, pest resistance, and unintended harm to non-target organisms, including humans, pets, and beneficial insects. In addition, repeated chemical exposure can contaminate indoor air quality and food sources, making such methods increasingly unsustainable. Manual inspections and conventional trap-based systems, though widely used, are often labour-intensive, provide limited coverage, and lack the ability to deliver real-time insights. They are prone to human error, inconsistent in performance, and incapable of tracking activity trends or infestation levels accurately. In light of these limitations, there is a growing need for intelligent, automated, and data-driven pest monitoring solutions that can offer continuous surveillance, timely alerts, and informed decision-making with minimal human intervention and maximum operational safety.

In recent years, the pest control industry has seen a shift toward smarter, more sustainable approaches leveraging digital technologies. Innovations such as electronic traps, sensor-based detection systems, and Internet of Things (IoT) connectivity have begun to transform pest monitoring from a reactive process to a proactive, data-driven practice. These systems offer the potential for automated detection, real-time alerts, behavioural analytics, and remote monitoring, thereby minimizing human intervention while improving accuracy and efficiency; however, most existing electronic pest monitoring systems are power consuming, complex, or limited in adaptability to different environments and pest types. Additionally, they often depend on continuous sensor polling and wireless data transmission, which significantly drains battery life, making long-term deployment costly and maintenance-intensive.

### SUMMARY

Accordingly, devices, systems, methods, and non-transitory computer-readable media for monitoring and capturing objects are disclosed herein.

According to one aspect, a system for monitoring and capturing one or more objects, comprising: a capturing unit, configured to target a specific category of object; one or more sensors, configured to generate signals indicative of an interaction activity; a microcontroller, configured to operate in a low-power mode and awaken upon receiving an interrupt signal from the sensor, and increment an interrupt counter and: when the interrupt corresponds to a first occurrence, in a given detection sequence, record a timestamp corresponding to the current time, and return to a low power or sleep state; a local data processor configured to pre-process the sensor signals, wherein preprocessing the sensor signals comprises: for subsequent interrupts, determine whether the elapsed time since the first interrupt exceeds a predetermined time threshold, when the elapsed time exceeds the threshold, is classify the event as a “sniffing” event, transmit a corresponding notification via a communication module, cause the system to return to the sleep state, and when the elapsed time does not exceed the threshold, determine whether the interrupt counter exceeds a predetermined count threshold, when the count threshold is exceeded, classify the event, and transmit a corresponding notification via a communication module; a communication module configured to transmit classified interaction data; and a user interface for real-time visualization of activity or notifications.

### BRIEF DESCRIPTION OF THE DRAWINGS

The details of the embodiments described, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates an example system for monitoring and capturing objects, in accordance with one example embodiment;

FIG. 4 illustrates a flowchart for real-time monitoring and capture of an object using the system of FIG. 3, according to one example embodiment;

FIG. 5 illustrates a flow chart for interrupt handling within the system of FIG. 3, according to one example embodiment;

FIG. 6A-C illustrate a physical implementation of the system of FIG. 3 in accordance with one example embodiment.

### DETAILED DESCRIPTION

After reading this description, it will become apparent to one skilled in the art how to implement the examples described herein through various alternative embodiments and alternative applications; however, although various embodiments are described herein, it is understood that these embodiments are presented by way of example and illustration only, and not limitation. As such, this detailed description of various embodiments should not be construed to limit the scope or breadth of the appended claims.

Reference throughout this specification to “one embodiment” or “an embodiment” means that a particular feature, structure or characteristic described in connection with the embodiment is included in at least one embodiment. Thus, the appearances of the phrases “in one embodiment”, “in certain embodiments”, or “in an embodiment” in various places throughout this specification are not necessarily all referring to the same embodiment. Furthermore, the particular features, structures, or characteristics of any of the embodiments disclosed can be combined in any suitable manner in one or more other embodiments.

In some embodiments, numbers have been used for quantifying weight percentages, angles, and so forth, to describe and claim certain embodiments of the invention and are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Various terms as used herein are shown below. To the extent a term used in a claim is not defined below, it should be given the broadest definition persons in the pertinent art have given that term as reflected in printed publications and issued patents at the time of filing.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context requires otherwise, throughout the specification that follow, the word “comprise” and variations thereof, such as “comprises” and “comprising” are to be construed in an open, inclusive sense that is as “including, but not limited to.”

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified.

The description that follows, and the embodiments described therein, is provided by way of illustration of an example, or examples, of particular embodiments of the principles and aspects of the present disclosure. These examples are provided for the purposes of explanation, and not of limitation, of those principles and of the disclosure.

As used herein, the term “object” refers to any target entity intended to be detected, monitored, or captured by the device. In preferred embodiments, the object includes, but is not limited to, pests such as cockroaches, ants, flies, mosquitoes, or other small crawling or flying arthropods that are commonly found in domestic, commercial, or agricultural environments.

The terms such as modular cartridge, cartridge, removable cartridge, and replaceable cartridge, used throughout the description, bear the same meaning.

In some aspects of the disclosure, systems, methods, and non-transitory computer-readable media are disclosed for monitoring and capturing objects.

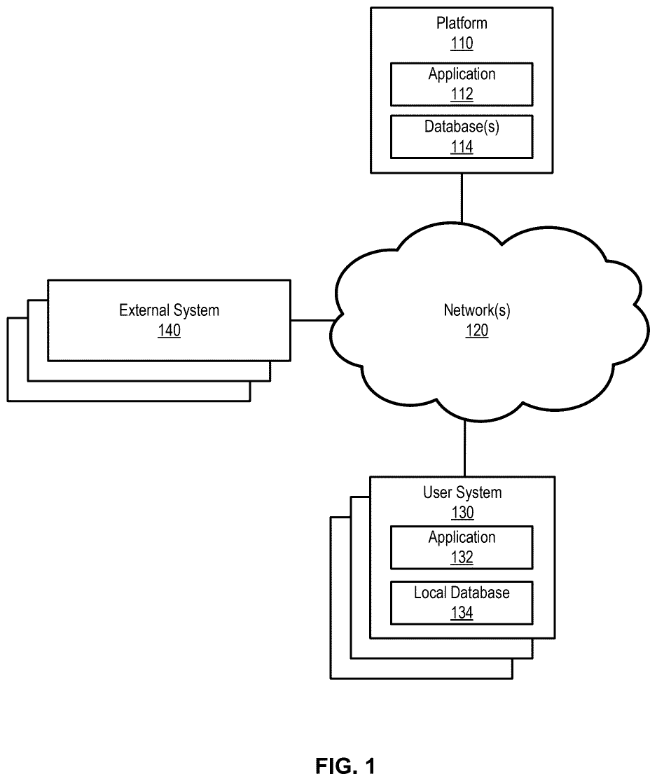

FIG. 1 illustrates an example infrastructure in which one or more of the disclosed processes may be implemented, according to an embodiment. The infrastructure can comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, 110 may be communicatively connected to one or more user systems 130 via one or more networks 120, or may be entirely implemented on the loopback (e.g., localhost) interface. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases. In addition, communication between any of these systems, for example, platform 110, user systems 130, and/or external system 140, may be entirely implemented on the loopback (e.g., localhost) interface.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134. In some aspects, an application 132 can be downloaded onto a user system 130, such as a user's phone or tablet that allows them to, for example, set up an account and log-on. While user system 130 and platform 110 are shown here as separate devices connected by a network 120. User system 130 may comprise an application 132 that may comprise one portion of a distributed cloud-based system that integrates with platform 110, for example, using a multi-tasking OS (e.g., Linux) and local only (localhost) network addresses.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, or may be entirely implemented on the loopback (e.g., localhost) interface, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST, GET, and PUT request supported by HTTP, via FTP, proprietary protocols, requests using data encryption via SSL (HTTPS requests), and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130 and potentially using a local database 134, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

While platform 110, user systems 130, and external systems 140 are shown as separate devices communicatively coupled by network 120, each of the devices shown as platform 110, user systems 130, and external systems 140 may be implemented on one or more devices, and/or one or more of platform 110, user systems 130, and external systems 140 may be implemented on a single device.

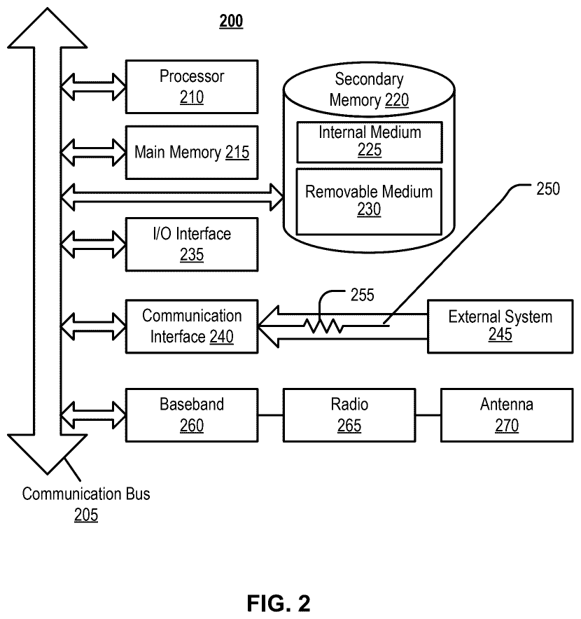

FIG. 2 is a block diagram illustrating an example wired or wireless system 200 that can be used in connection with various embodiments described herein. For example, system 200 may be used as or in conjunction with one or more of the functions, processes, or methods (e.g., to store and/or execute the software) described herein, and can represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

Embodiments of processes for monitoring and capturing objects will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Thus as noted above, and in accordance with one example embodiment, a system for monitoring and capturing objects.

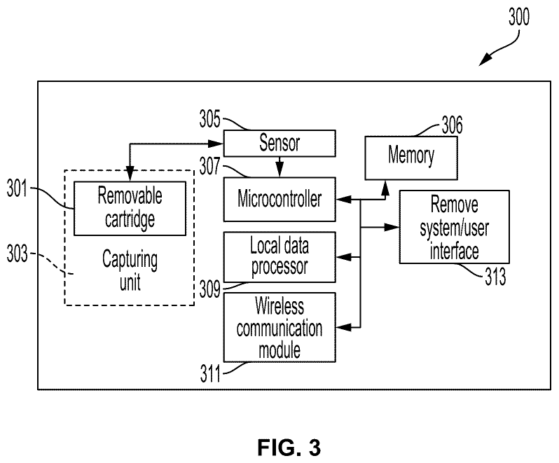

FIG. 3 illustrates an example system 300 for monitoring and capturing one or more objects, wherein the system employs a low-power, interrupt-driven structure for efficient activity detection, in accordance with one embodiment. System 300 comprises at least one removable cartridge 301, at least one capturing unit 303, one or more sensors 305, a microcontroller 307, a local data processor 309, a wireless communication module 311, and user interface 313 for real-time visualization of activity or notifications. It should be noted that in certain embodiments, various components illustrated in FIG. 3 can be incorporated into a single integrated circuit, or chip. For example, microcontroller 307 and data processor 309 can be included in a single circuit. It should also be clear that system 300 can be implemented via a processing system 200 as described above.

In certain embodiments, the sensors 305 can be selected from, but are not limited to, motion sensors, vibration detectors, and/or proximity sensors. These sensors can include, for example, Hall Effect sensors, beam break sensors, microphones, accelerometers, infrared (IR) sensors, capacitive touch sensors, pressure sensors, load cells, optical detectors, image sensors, cameras, vision-based sensors, temperature sensors, or some combination thereof. Each type of sensor can be strategically chosen and placed depending on the capturing unit 303 structure and intended function. For example, beam break sensors can be used in bait stations to detect the entry of an object, while accelerometers or pressure sensors can detect vibrations or force from a triggered snap trap. Microphones can be used to capture sound signatures of capture unit 303 activation, and vision-based sensors or cameras can provide visual confirmation or classification of the trapped object. These sensors 305 generate electrical signals upon detecting activity, which are then processed by data processor 309 for further analysis, classification, or transmission.

Thus, system 300 can comprise a low-power microcontroller 307 that includes dedicated interrupt pins. These interrupt pins are electrically coupled to one or more environmental or object interaction sensors 305, such as motion sensors, vibration detectors, or proximity sensors. The microcontroller 307 can be configured to operate in an interrupt-driven architecture, wherein it remains in a dormant or sleep state to conserve energy under idle conditions. Upon detection of a significant activity such as motion, vibration, sound, or contact activity, the corresponding sensor 305 generates an interrupt signal. This signal is transmitted to the microcontroller 307 via the interrupt pin, thereby triggering an immediate wake-up response from, e.g., a dormant or sleep state.

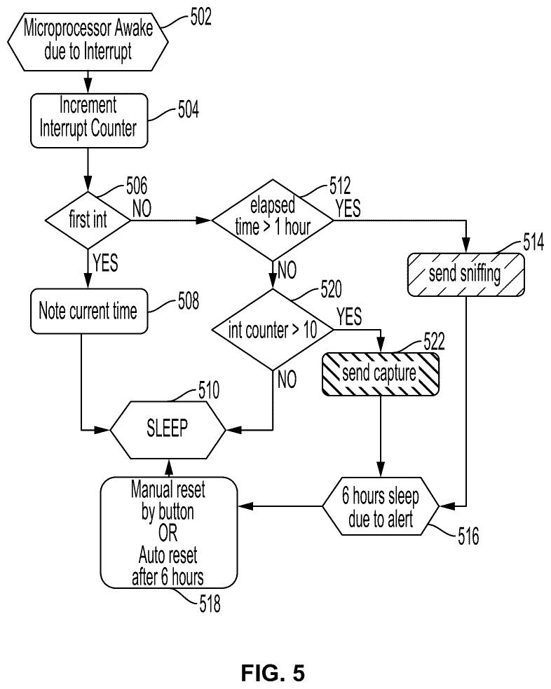

The interrupt-driven wake mechanism ensures minimal latency between the occurrence of a triggering activity and the activation of the microcontroller 307, allowing for real-time monitoring with high energy efficiency. Once awakened, the microcontroller 305 and/or data processor 309 processes the incoming sensor data to determine whether the interaction corresponds to a legitimate capture activity, as described with respect to FIG. 5, such as the presence or entrapment of a target object. System 300 can be configured to evaluate multiple sensor parameters, such as signal intensity, duration, and pattern, to distinguish valid activities from environmental noise or false triggers. This architecture enables system 300 to intelligently monitor activity with minimal power consumption, making it highly suitable for battery-operated or remote deployment scenarios.

In some embodiments, the microcontroller 305 can be further configured to store, e.g., in memory 306, relevant metadata associated with the capture activity before initiating data transmission. Such metadata can include, but is not limited to, a sensor ID (identifying which specific sensor 305 was triggered), capture ID (identifying the activity or trap), and timestamp (indicating the exact time of occurrence). This data can either be temporarily stored in on-board memory 306 or logged in a structured format, and subsequently transmitted wirelessly to a central hub, gateway, or cloud platform, e.g., platform 110 for aggregation, monitoring, and analysis. This design facilitates efficient, real-time monitoring of multiple distributed capturing units while conserving power and bandwidth.

In certain embodiments, the system 300 can include a local data processor 309, either as a standalone circuit or as part of the microprocessor 307. This data processor 309 can be configured to receive raw sensor signals from one or more sensors 305 embedded, such as Hall Effect sensors for detecting magnetic field changes, beam break sensors for object presence, microphones for acoustic signals, accelerometers for motion detection, infrared (IR) sensors for heat or proximity sensing, capacitive touch sensors for surface interaction, pressure sensors or load cells for force detection, optical detectors for light-based signals, image sensors or cameras for visual monitoring, and vision-based sensors or temperature sensors to detect heat or environmental changes. The data processor 309 can be configured to collect raw data from these sensors 305 and perform on-device signal conditioning and pre-processing tasks, such as filtering, normalization, noise reduction, and feature extraction. By performing local processing, the system 300 significantly reduces the volume of raw data that needs to be transmitted to a central server or cloud, e.g., platform 110, thereby enhancing bandwidth efficiency and reducing latency.

Data processor 309 can be configured to execute a machine learning-based classification algorithm that has been trained to analyze the pre-processed sensor data in real-time. Such an algorithm can be capable of identifying and classifying capture-related activities by detecting patterns and signal features that correspond to specific object interactions with the capturing unit 303.

Such a machine learning model can be trained on historical data representing various object behaviors and interactions, enabling the classification algorithm to categorize activities into activity types such as Entry (detection of an object entering the capture unit), Exit (object leaving the capturing unit without capture), Sniff (brief or hesitant interaction with the capturing unit or bait), Capture (successful retention of the object within the unit), Reset (mechanical or manual resetting of the capturing unit), Activity Count (cumulative count of significant interactions), and False-Positive Trigger (activities caused by environmental noise or unintended stimuli). This on-device intelligence enables the system 300 to distinguish between meaningful and non-meaningful activities, thereby enhancing accuracy, reducing false positives, and optimizing communication by transmitting only high-value activities to a central server or cloud platform 110. Such an architecture supports scalable, low-latency, and energy-efficient monitoring of multiple capturing units deployed in the field.

In certain embodiments, system 300 can comprise a communication module 311, such as a wireless communications module, operatively connected to the processing and classification subsystem, comprising microcontroller 307, data processor 309 and memory 306. The, e.g., wireless communication module 311 can be configured to transmit classified interaction data, specifically, data related to capture activities, to a remote server, cloud interface, or centralized monitoring platform 110. The transmitted data can include timestamped activity types, sensor readings, activity classifications, or status notifications associated with the operation of the capturing unit 303.

Such a wireless communication module 311 can be designed to operate using low-power wide-area network (LPWAN) protocols to ensure energy efficiency and extended field deployment. The communication protocol can be selected from, but not limited to, LoRa (Long Range), NB-IoT (Narrowband Internet of Things), Wi-Fi, ZigBee, Z-Wave, Bluetooth Low Energy (BLE), or other mesh-based or low-energy communication standards suitable for distributed environmental monitoring systems. In certain embodiments, the communication module 311 can be configured to initiate data transmission only upon the detection and validation of capture-related activities, as determined by the system's on-device classification logic as implemented by the classification subsystem. This selective transmission approach minimizes unnecessary data transfer, conserves power, and ensures that only relevant, high-priority data is communicated to a central server or cloud platform 110.

System 300 can further comprise an integrated power source (not shown) configured to support extended autonomous operation in the field without requiring frequent maintenance or battery replacement. The power source can include one or more batteries, capacitors, or energy harvesting elements such as photovoltaic cells, thermoelectric generators, or kinetic energy harvesters, and is operatively coupled to the electronic components of the system 300, including but not limited to the sensor module 305, classification subsystem, and communication module 311.

System 300 can be designed with energy optimization as a core consideration, employing both hardware and software-level strategies to minimize power consumption. These strategies can include, for example, low-power microcontrollers, sleep/wake cycles triggered by activity-based interrupts, duty cycling of non-essential components, and intelligent scheduling of data transmissions. The combination of these features allows the system 300 to function effectively over prolonged durations in remote or resource-constrained environments, without compromising the accuracy or reliability of its object monitoring and classification functions.

The power source is dimensioned and selected based on the expected deployment conditions and frequency of interaction activities, thereby ensuring that the system remains active and responsive throughout the intended monitoring cycle.

In one example, system 300 can be powered by a primary lithium battery such as a CR123A cell with a capacity of about 1650 mAh. Based on typical usage patterns, which may, for example, include approximately twelve approach events (sniff alerts), two capture events (catch alerts), and fifty-two health checks per year, the additional energy consumed by the weekly health checks is less than about 3 mAh annually. Even with this added consumption, system 300 can achieve a practical operating life of about seven to ten years, depending on the wireless protocol employed, e.g., LoRa, Wi-Fi, or Bluetooth Low Energy. This long-life power arrangement allows the system 300 to operate in the field for extended periods without frequent battery replacement, enabling reliable deployment in residential, commercial, or industrial environments while reducing servicing requirements and overall maintenance costs.

System 300 can also comprise a comprehensive user interface 313 designed for real-time monitoring and visualization of capture-related activity, alert notifications, and system performance. This interface can be implemented as an intuitive graphical user interface (GUI) accessible through various platforms, including mobile apps, desktop software, web-based dashboards, as well as a display integrated with unit 303.

The user interface 313 can, therefore be seamlessly integrated with the communication module 311, such that it receives classified data such as object entry and exit, sniffing, capture activities, false positives, and system resets either from a local processor 309 or a remote server 110.

The user interface 313 can be supported across a wide range of computing devices capable of wired or wireless communication, including desktops, laptops, tablets, smartphones, servers, smart TVs, gaming consoles, kiosks, set-top boxes, and point-of-sale systems. These devices can operate through a dedicated client application, which facilitates interaction with the system, access to real-time alerts, and retrieval of historical data stored either locally or in connected databases. The interface 313 presents information through user-friendly components such as time-stamped activity logs, activity charts, heat maps, and alert indicators. Additional functionalities may include configurable notifications (via push alerts, email, or SMS), trend analysis tools, user authentication, and data export options. This robust configuration ensures that users can conveniently monitor and manage pest capture activities with precision and flexibility, regardless of the device or location.

In a further embodiment, the system for monitoring and capturing one or more objects is specifically configured for targeted object types, including but not limited to rodents, mosquitoes, cockroaches, ants, bedbugs, squirrels, or birds. The structural and functional elements of the system, such as capture mechanism, sensor sensitivity, attractant formulation, and capture parameters are adapted to suit the behavioral characteristics and physiological traits of the selected species. Thus, system 300 can include one or more modular cartridges 301 that are configured to interact with the objects or other target species. Each modular cartridge 301 can be independently insertable and replaceable, allowing for flexibility in function and customization based on the target environment or species.

These modular cartridges 301 can comprise one or more attractants designed to lure the object toward or into the capturing unit 303. These attractants can include chemical means such as pheromones, food-based lures, or scent compounds tailored to attract specific types of objects, or physical means such as colour, texture, heat, or sound elements that may audio-visually or physically attract or stimulate the object to approach the capturing unit.

In certain embodiments, the modular cartridge(s) 301 further includes an adhesive layer or region strategically positioned to retain the object once it makes contact with the attractant. The adhesive can be pressure-sensitive, non-drying, or thermally stable, depending on the operational environment. This arrangement aids in temporarily or permanently immobilizing the object for detection, monitoring, or removal.

The modular nature of the cartridge 301 allows for easy replacement or substitution with cartridges containing different attractants, adhesives, or configurations and conditions of the cartridge based on desired operational parameters or object profiles.

In some embodiments, the interrupt-driven object monitoring and capture system 301 can be incorporated into or integrated with capturing unit 303, thereby enabling both passive and intelligent object detection functionalities. The capturing unit 303 can be selected from, but are not limited to, glue traps, snap traps, flip traps, bait stations, electric traps, sensing trays, electronic repellent traps, spring-loaded traps, and humane capture-and-release traps, or combinations thereof. The capturing unit 303 serves the primary function of physically trapping, deterring, or monitoring objects, while the rest of system 300 adds value by sensing, recording, or classifying the object interaction activity.

In a specific embodiment, the system 300 is coupled with the capturing unit 303 by means of suitable attachment mechanisms, wherein all functional components are housed within or securely attached to the capturing unit 303, enabling system 300 to operate as an independent, self-contained device. Such mechanisms can include, but are not limited to, mechanical fasteners, snap-fit connectors, slide-in rails, magnetic couplings, adhesive bonding, or integrated housing designs, optionally combined with electrical connectors to facilitate power and data transfer between components.

As noted above, sensor(s) 305 can be configured to detect a triggering activity such as motion, vibration, or object presence, and generate an interrupt signal when activity crosses a defined threshold within a pre-set time window. This signal is processed via a classification flowchart (see FIG. 5) to determine the validity of the activity. If inconsistencies are found, a machine learning model is activated to analyze additional parameters like signal frequency and duration to confirm the nature of the interaction. Once verified as an object, the system 300 captures and logs the activity, optionally triggering auxiliary features like notifications or cameras, and can transmit the data to a remote system, such as platform 110, e.g. via communications module 311. This intelligent, adaptive approach reduces false positives and supports real-time, efficient monitoring across various capture units 303 and systems 300. These sensors 305 serve as the primary means of capture activity detection, enabling the system 300 to identify the presence, approach, engagement, or capture of a specific object within or near the capturing unit 303.

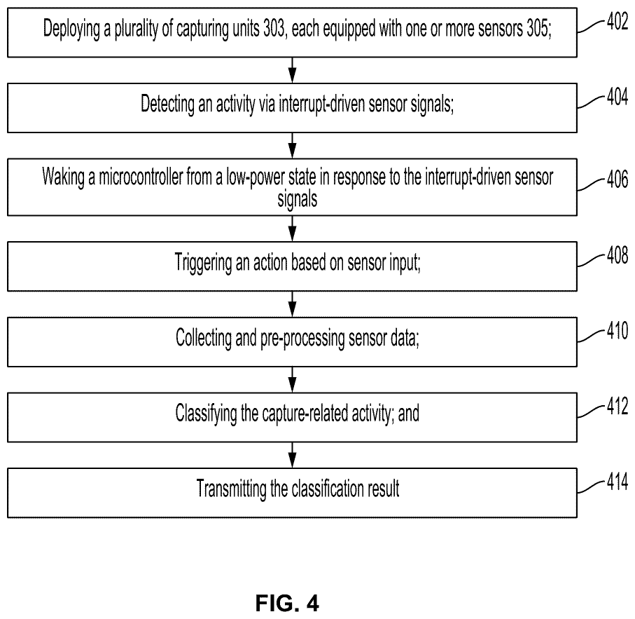

FIG. 4 is a flow chart illustrating an example process for detecting the presence of an object on cartridge 301within capturing unit 303. First, in step 402 one ore more capturing units 303 can be deployed that include sensors 305 specific to the type of object being targeted. As explained above and below, an important part of the operation of system 300 is that the system can operate in an extremely low power mode, due to the fact that it is interrupt driven. In other words, the components of system 100 can be in an off, sleep or other low power mode, only powering up upon receiving an interrupt, e.g., generated by a sensor 305. This interrupt can be time driven or activity driven (step 404) as described in more detailed with respect to FIG. 5.

The interrupt will cause microcontroller 307 to wake up, or come out of a low power mode in step 406, and trigger local data processor 309 to also wake up and take action based on the detected activity in step 408.

Data processor 309 can then collect and pre-process the data from sensor 305 in step 410 and classify the activity in step 412. In step 414, system 300 can transmit the data, e.g., to platform 110.

In one embodiment, the system uses threshold values to decide how to treat sensor activity. These thresholds may be set for a specific pest, changed by the user, or left as default values if the pest type is not known. The thresholds can include both a time window and an interrupt count within that window. For example, system 300 can observe activity within one hour, and if the number of interrupt signals during that time exceeds a set count, such as more than ten, the event is classified as a capture. If the number of signals is lower or spread out over the hour, the event may be classified as a sniffing or approach event. By combining time and count thresholds in this way, the system reduces false alerts and works reliably across different traps and pests, as shown in the process of FIG. 5.

FIG. 5 illustrates a flow chart for interrupt handling within a system 300, according to one example embodiment. System 300 can be configured to use threshold values that change depending on the pest/object to be captured. For example, a glue trap set for mice may use a short time window, while the same trap used for snakes may need a longer time window. These values can be set in advance from known pest behavior or adjusted by the user. If the pest type is not known, system 300 can be configured to use a default range that works for, e.g., common rodents or insects, and can adjust itself over time using adaptive software depending on the interactions and encounters with pests/objects.

Referring to FIG. 5, upon receiving an interrupt signal from one or more sensors 305, in step 502, system 300 can transition from a low-power sleep mode to an active state and increment an interrupt counter in step 504. If the interrupt corresponds to a first occurrence, as determined in step 506, in a given detection sequence, the system 300 can record a timestamp corresponding to the current time in step 508 and return to a low power or sleep state in step 510. For subsequent interrupts, system 300 can determine whether the elapsed time since the first interrupt exceeds a predetermined time threshold, for example, approximately one hour, in step 512. If the elapsed time exceeds the threshold, the event is classified as a “sniffing” event in step 514 and a corresponding notification can be transmitted, e.g., to user interface user interface 313 and/or platform 110. The system 300 can then be placed in a 6 hour sleep mode in step 516 and transition back to the sleep mode (step 510).

If the elapsed time does not exceed the threshold, system 300 further determines whether the interrupt counter exceeds a predetermined count threshold, for example, greater than ten interrupts, in step 520. If the count threshold is exceeded, the event is classified as a “capture” event in step 522 and a corresponding notification can be transmitted. Following the transmission of a classified event, the system transitions into a defined sleep state, in step 516, or remains in the sleep state until a manual reset is performed in step 518. In certain implementations, the foregoing threshold-based and count-based logic may be replaced or supplemented by, e.g., a machine learning-based classification algorithm trained to distinguish between event types such as entry, exit, sniff, capture, reset, activity count, or false-positive triggers, based on sensor signal patterns.

It should be noted as described above that the notification can be transmitted, e.g., to a platform 110 that can characterize, classify, track, etc. the activity. Such a platform 110 can then allow this information to be accessed, e.g., via a browser or a portal so that a user associated with the system 110 can get actionable information. Alternatively, a user system 132 cab be used to access the information after it has been sent to user system 132. Thus, the user can get notification, the dashboard, etc., on their user system 132.

In certain embodiments, the transmission can actually go to the user system 132 first, or in tandem with platform 110, and some or all of the post processing of the information can be performed on user system 132.

As noted, above, capturing unit 303 can comprise a housing with a cavity, compartment, area, etc., into which the removable cartridge can be placed, if required. The sensors 305 and the rest of the system 100 can then be in communication with or incorporated into the housing.

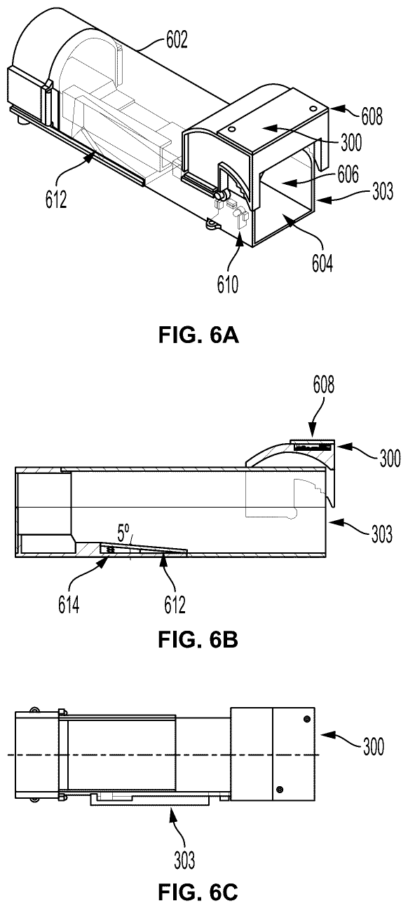

FIGS. 6A-C illustrates such an embodiment. Here the capturing unit 303 can comprise a housing 602 that includes a cavity or compartment, etc., 606, into which the target object would enter. A removable cartridge 301 that includes an attractant can be placed within cavity 606 to attract a specific object. In this example, a mechanism 612 can be included that can be configured to sense pressure, when the object in present. Thus, for example, the cartridge 301 can be placed on mechanism 612 so as to attract the object to mechanism 612.

As can be seen in side the side view of FIG. 6B, mechanism 612 can comprise a pedal that is raised at an angle, with a, e.g., spring 614 underneath. The strength of the spring can be configured such that only an object of a certain weight can compress the spring 614 to ensure that only target objects are capture. Thus, sensor 305 can be configured such that the sensor 305 can detect the compression of the pedal, which will trigger the interrupt process of FIG. 5.

In the example of FIGS. 6A-C, the housing also comprises a door 608 that can be configured to shut and latch, e.g., via a latch 610. The door 608 can be triggered to shut when the object is detected either mechanically or via an electronic signal, e.g., from system 100.

As can be seen in FIGS. 6A-C, the rest of system 300 can be incorporated into housing 602. In some embodiments, the system 300 can be built on a printed circuit board (PCB) that is mounted within the housing 602, in this case door 608, of the capturing unit 303. The PCB can be fixed in place using molded standoffs, screws, or clips. The motion sensor 305 can then be positioned so that it makes mechanical contact with, or is in close proximity to, a part of the trap that moves or vibrates when the trap is triggered, such as a pedal, latch, or housing wall. This ensures that the sensor 305 receives a clear signal whenever the trap is activated.

In other embodiments, the PCB and battery if required can be assembled as a self-contained cartridge that fits into a dedicated slot or cavity within the capturing unit 303 with electrical contacts automatically engage when the cartridge is inserted. Such as design allows the electronics to be replaced or upgraded without changing the rest of the trap. In certain implementations, system 300 can comprise an integrated power source, such as a battery or energy harvesting device, e.g., photovoltaic cell, operatively coupled to the electronic components of system 100, with an optional charge management circuit (not shown) for regulating and storing harvested energy, and thereby enabling extended autonomous operation in the field without frequent maintenance.

In some embodiments, the capturing unit 303 can be made from materials chosen for strength, easy manufacturing, and environmental needs. The system may use a printed circuit board made from fiberglass epoxy, flexible polyimide, or ceramic, and can be coated with epoxy, silicone, or polyurethane to protect it from moisture and dust. The cartridge that holds the system may be made from plastics such as ABS, polycarbonate, polypropylene, or nylon, or from metals like aluminum or stainless steel for stronger designs. For disposable models, biodegradable plastics such as PLA may also be used. The capturing unit 303, including the housing 602 and any moving parts, may be made from molded plastics, sheet metal, or a mix of both. Springs can be steel or copper alloys, and the bait compartment can be made from food-safe plastics or corrosion-resistant metal. Extra coatings such as powder coat, anti-corrosion layers, or antimicrobial finishes may be added when needed. Other materials and equivalents known in the art may also be used, depending on cost, durability, or regulatory requirements, without departing from the scope of the invention.

In certain embodiments, system 300 can be housed in a small module that attaches to the outside of the capturing unit 303. This may be achieved by a clip, adhesive pad, or magnetic mount. In this arrangement, the module detects motion or vibration through the trap wall and transmits data wirelessly, making it suitable for retrofitting conventional traps.

Again, system 300 can be configured to target specific pest types, including but not limited to rodents, mosquitoes, cockroaches, ants, bedbugs, squirrels, or birds. The modular and adaptable design allows for adjustment of cartridges, sensors, and attractants to suit the behavioral and physical characteristics of different object categories, thereby increasing the precision and effectiveness of the system in various operational environments.

Further, in some embodiments, the housing of the apparatus is designed to be discreet by mimicking or being integrated into surrounding ambient structures. Such structures include indoor or outdoor elements like furniture, wall panels, utility access points, packaging materials, or other commonly encountered items. This concealed configuration ensures that the apparatus remains unobtrusive and does not raise suspicion or avoidance behavior in the target objects, while also maintaining aesthetic compatibility with the environment in which it is deployed.

The system collects and pre-processes sensor data locally, enabling efficient and timely analysis. A machine learning model stored in memory is utilized to classify the nature of the detected interaction or capture-related activity. Based on the classification outcome, the system generates a report or signal which is then transmitted via a communication interface to a remote system or server, e.g., platform 110, for further processing, logging, or user notification. This method supports intelligent, power-efficient, and automated operation suitable for deployment in various object monitoring and capture scenarios.

In a further embodiment of the invention, the method for real-time monitoring and capture additionally comprises generating actionable notifications, signals, or insights that are accessible through a centralized dashboard interface. These outputs may be tailored based on the type of activity detected, e.g., motion, vibration, or capture activity, the specific location or interaction unit involved, and the overall performance or health status of the deployed units. This enables end-users or facility managers to remotely monitor trends, respond to capture-related activities efficiently, and manage object control efforts with increased precision.

In yet another embodiment, the machine learning model used for classifying the capture-related activity is designed to improve its performance over time. The model can be trained and updated dynamically using additional sensor data gathered during operation or through feedback provided by users. This continuous learning process enhances the accuracy and reliability of activity classification, allowing the system to adapt to varying conditions and object behaviors across different environments.

### EXAMPLES

The present disclosure is further explained in the form of following examples. However, it is to be understood that the examples are merely illustrative and are not to be taken as limitations upon the scope of the invention. Various changes and modifications to the disclosed embodiments will be apparent to those skilled in the art. Such changes and modifications may be made without departing from the scope of the invention.

### Example 1: Low-Power Rodent Trap

In an example, a low-power rodent trap system includes a modular cartridge containing a glue-based capture mechanism, along with a pressure sensor and an accelerometer to detect movement and physical interaction of rodents. The device is attached to the capturing unit and monitors any motion indicating rodent activity. A microcontroller embedded in the unit remains in a low-power sleep mode and wakes only upon receiving an interrupt signal from the sensors. Upon activation, it logs relevant metadata, processes the sensor data using a pre-trained local machine learning model, and classifies the activity. If identified as a valid capture, the data is transmitted via Bluetooth Low Energy (BLE) to a user interface. A centralized dashboard displays real-time activity logs and visual heatmaps, enabling staff to monitor infestation zones and schedule targeted clean-up or maintenance.

### Example 2: Smart Flying Insect Trap with Optical Sensing

In an example, a smart insect trap system targets flying pests such as mosquitoes or flies. The device incorporates a UV light lure and a high-speed fan-based suction mechanism housed in a compact cartridge. Detection is achieved using an optical sensor array with photodiodes and IR beam interruption logic to detect the entry and entrapment of insects. A microcontroller remains in sleep mode and is awakened through an interrupt triggered by beam interruption. Upon activation, the device runs an on-board machine learning algorithm to classify movement patterns and airflow disturbances. If a valid trapping activity is confirmed, data is logged and transmitted via ZigBee mesh networking to a centralized monitoring hub, allowing large-scale facility-wide pest surveillance and control with minimal power usage.

### Example 3: Smart Cockroach Monitoring Unit With Multi-Sensor Array

In an example for cockroach monitoring, a compact device is equipped with a glue trap integrated with a thermal sensor, proximity IR sensor, and a low-resolution camera. The IR sensor detects movement within range and wakes the processor. The camera captures a frame, which is analyzed via a Convolutional Neural Network (CNN) trained to recognize cockroach body shapes and movement patterns. The system optionally uses Wi-Fi Direct to send the image and activity classification to a secure mobile application for real-time updates. The device operates on rechargeable batteries and includes a solar trickle charging feature, making it suitable for deployment in both residential and commercial settings.

### Example 4: Bed Bug Monitoring Device With Chemical and Pressure Sensors

In an example targeting bed bugs, the system is designed as a low-profile mat placed under mattresses or upholstery. It uses chemical sensors to detect pheromone compounds released by bed bugs and thin-film pressure sensors to capture minor displacements caused by insect movement. Upon chemical detection or tactile stimulus, the system wakes the microcontroller, which initiates activity processing using a classification model trained on correlated sensor patterns. Confirmed activities trigger transmission of data via NB-IoT (Narrowband Internet of Things) for low-power, wide-area communication in hotels or dormitories. Historical trend data is aggregated in a remote server to evaluate infestation progression over time.

Thus, specific examples embodiments of devices, systems and methods for monitoring and capturing objects have been disclosed. Various modifications to these embodiments will be readily apparent to those skilled in the art, and the general principles described herein can be applied to other embodiments without departing from the spirit or scope of the description herein. Thus, it is to be understood that the description and drawings presented herein are therefore representative of the subject matter which is broadly contemplated by the present embodiments. It is further understood that the scope of the present description fully encompasses other embodiments that may become obvious to those skilled in the art and that the scope of the present invention is accordingly not limited.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

As used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

Reference throughout this specification to “an embodiment” or “an implementation” means that a particular feature, structure, or characteristic described in connection with the embodiment is included in at least one embodiment or implementation, but can also be included in other embodiments described herein or that would be obvious based the present description. Thus, appearances of the phrases “in an embodiment” in various places throughout this specification are not necessarily all referring to the same embodiment or a single exclusive embodiment. Furthermore, the particular features, structures, or characteristics described herein may be combined in any suitable manner in one or more embodiments or one or more implementations.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Certain numerical values and ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

All structural and functional equivalents to the components of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for monitoring and capturing one or more objects, comprising:
a capturing unit, configured to target a specific category of object;
one or more sensors coupled with the capturing unit, configured to generate signals indicative of an interaction activity with the capturing unit;
a processor configured to execute instructions, the instructions configured to cause the processor to:
operate in a low-power mode and awaken upon receiving an interrupt signal from the one or more sensors, and increment an interrupt counter in response to receiving the interrupt signal and:
when the interrupt corresponds to a first occurrence, in a given detection sequence, record a timestamp corresponding to the current time, and
return to a low power or sleep state;
pre-process the sensor signals, wherein preprocessing the sensor signals comprises:
for subsequent interrupts, determine whether the elapsed time since the first interrupt exceeds a predetermined time threshold,
when the elapsed time exceeds the threshold, classify the event as a “sniffing” event,
transmit a corresponding notification via a communication module,
cause the system to return to the sleep state, and
when the elapsed time does not exceed the threshold, determine whether the interrupt counter exceeds a predetermined count threshold,
when the count threshold is exceeded, classify the event, and
transmit a corresponding notification via a communication module;
a communication module configured to transmit classified interaction data; and
a user interface for real-time visualization of activity or notifications.

2. The system of claim 1, further comprising a removable cartridge for use in conjunction with the capturing unit.

3. The system of claim 2, wherein the cartridge comprises:
one or more attractants, including a chemical and physical means for attracting, retaining or interacting with the objects; and
an adhesive.

4. The system of claim 1, wherein the capturing unit is removably fitted into a housing.

5. The system of claim 1, wherein the capturing unit is selected from, but not limited to, glue traps, snap traps, flip traps, bait stations, electric traps, sensing trays, electronic repellent traps, humane capture-and-release traps, or combinations thereof.

6. The system of claim 1, wherein the one or more sensors comprise at least one of Hall effect sensors, beam break sensors, microphones, accelerometers, infrared (IR) sensors, capacitive touch sensors, pressure sensors, load cells, optical detectors, image sensors, cameras, vision-based sensors or temperature sensors.

7. The system of claim 1, further comprising a memory coupled to the processor, the memory configured to store instructions, including firmware or software, for classifying capture-related activities.

8. The system of claim 7, wherein the memory is configured to store metadata including sensor ID, capture ID, and timestamp prior to wireless transmission.

9. The system of claim 1, wherein classifying the event comprises classifying the event into one or more categories selected from entry, exit, sniff, capture, reset, activity count or false-positive trigger.

10. The system of claim 1, wherein the communication module utilizes a low-power wide-area network protocol selected from LoRa, NB-IoT, Wi-Fi, ZigBee, Z-Wave, BLE or other low-power or mesh-based communication protocols, and is configured to transmit only upon occurrence of a validated capture-related activity.

11. The system of claim 1, wherein the system further comprises a power source configured to support extended operational life through optimized energy usage.

12. The system of claim 11, wherein the power source comprises one or more batteries, capacitors, or energy harvesting elements, including photovoltaic cells, operatively coupled to the sensor module, microcontroller, local data processor, and communication module.

13. The system of claim 1, wherein the user interface is implemented as a web application or mobile application configured to receive event data to visualize capture-related activity data, alerts, and capture performance metrics in real time.
